(19) United States
(12) Patent Application Publication
(10) Pub. No.: US 2010/0119567 A1
(43) Pub. Date: May 13, 2010

(54) INSECTICIDAL COMPOSITION AND ARTICLES OBTAINED THEREOF

(75) Inventors: Pierre Herben, Ixelles (BE); Gabriella Sartori, Ferrara (IT); Fablo Di Pietro, Ferrara (IT)

Correspondence Address: BASELL USA INC., NEWTOWN SQUARE CENTER, 3801 WEST CHESTER PIKE, BLDG. B, NEWTOWN SQUARE, PA, 19073, US

(73) Assignee: Basell Polyolefine GmbH, Wesseling (DE)

(21) Appl. No.: 12/451,593

(22) PCT Filed: May 6, 2008
(86) PCT No.: PCT/EP2008/055562

§ 371 Date: Nov. 20, 2009

Related U.S. Application Data
(60) Provisional application No. 60/932,565, filed on May 31, 2007.

(30) Foreign Application Priority Data
May 23, 2007 (EP) 07108783.7

(51) Int. Cl. A01N 25/34; A01N 65/00; A01P 7/04

(52) U.S. Cl. 424/411; 514/74

(57) ABSTRACT

A material having insecticidal and acaricidal properties comprising:
A) From 99.95 by weight to 70.0% by weight a propylene based polymer having the following properties:
iii) a Melt Flow Rate (MFR) (ISO 1133) comprised between 11 and 40;
iv) Isotactic pentads (mmmm) higher than 90%;
B) From 0.05% to 30% by weight of an adduct of formula T¹-T² resulting from the condensation of T¹ and T², wherein
T¹ comprises at least one pyrethroid substance, which is substantially stable up to a temperature of at least 150° C.;
T² is an ethylenically unsaturated substance chooses from the group consisting of:
(a) a surfactant
(b) vinyl phospates and
(c) mixtures thereof.

This application is the U.S. national phase of International Application PCT/EP2008/055562, filed May 6, 2008, claiming priority to European Application 07108783.7 filed May 23, 2007 and the benefit under 35 U.S.C. 119(e) of U.S. Provisional Application No. 60/932,565, filed May 31, 2007; the disclosures of International Application PCT/EP2008/055562, European Application 07108783.7 and U.S. Provisional Application No. 60/932,565, each as filed, are incorporated herein by reference.

The present invention relates to a material having insecticidal and acaricidal properties comprising a pyrethroid substance and a propylene polymer.

WO2004/089086 relates to a composition comprising a pyrethroid substance and a compound having an ethylenically unsatured group. The composition described in that patent application can be used as an additive for a polymeric composition in order to obtain a final material able to release an insecticidal flux. This material is useful for the production of various articles such as fibers and mosquito-nets. But can bee used as well for other extruded items as films, Thermoformed or Injection moulded items.

Propylene polymer is a versatile thermoplastic material compatible with many process techniques, it has a moderate costs and favorable properties for many applications.

Thus it represents a valid alternative for the production of the material described in WO2004/089086.

Among other polymeric materials WO2004/089086 cites in a generic way that polypropylene can be used. No examples of the use of this material with the composition taught in WO 2004/089086 are present. A general isotactic polypropylene is used only in a comparative example. In this example the polypropylene polymer is not characterized. Propylene polymers represent an economic alternative for the production of the material described in WO2004/089086.

Therefore the applicant has found that when a particular polypropylene polymer a specific range of Melt flow rate (MFR) is used it is possible to improve the characteristics of this insecticidal material. In fact as shown in the examples of this application when the propylene polymer according to the present invention is used the flow of the insecticidal composition is higher if compared with the flow obtainable with other propylene polymers.

An object of the present invention is a material having insecticidal and acaricidal properties comprising:
A) From 99.95 by weight to 70.0% by weight a propylene based polymer having the following properties:
i) a Melt Flow Rate (MFR) (ISO 1133) comprised between 10 and 40; preferably between 12 and 35, more preferably between 15 and 33;
ii) Isotactic pentads (mmmm) higher than 90%; preferably higher than 91% and more preferably higher than 92%;
B) From 0.05% to 30% by weight of an adduct of formula T¹-T² resulting from the condensation of T¹ and T², wherein
T¹ comprises at least one pyrethroid substance, which is substantially stable up to a temperature of at least 150° C.; preferably substantially stable up to temperature of at least 300° C.;
T² is an ethylenically unsaturated substance chooses from the group consisting of:
(a) a surfactants
(b) vinyl phospates and
(c) mixtures thereof.

Preferably from 99.9% to 80% by weight of (A) and from 0.1% and 20% by weight of B is used; more preferably from 99.5% by weight to 85% by weight of A and 0.5% by weight to 15% by weight of B is used, even more preferably from 99% by weight to 95% by weight of A and 1% by weight to 5% by weight of B is used

The propylene based polymer (A) is a propylene homopolymer, a propylene copolymer or a mixture thereof. The propylene copolymer contains from 0.1 to 50% by mol of derived units of ethylene or an alpha-olefin of formula CH₂═CHZ wherein Z is a linear or branched C₂-C₂₀ radical; preferably said propylene copolymer contains from 1 to 15% by mol of ethylene or said alpha-olefin; preferred comonomers are ethylene and 1-butene.

The propylene based polymer (A) is a commercial polypropylene polymer. It can be obtained either by using catalyst system based on Titanium and magnesium or by using metallocene-based catalyst systems.

The Adduct T¹-T² has been described in WO 2004/089086. Preferably The Adduct T¹-T² has a solubility in ethanol of greater than or equal to 75 wt. %, more preferably between 75 and 90 wt. %.

Preferably the Adduct T¹-T² comprises from 75 to 96% by weight of T¹ and from 25% to 4% by weight of T². Preferably T1 is chosen from the group consisting of pyrethroids which are substantially stable up to a temperature of at least 150° C., and preferably substantially stable up to a temperature of at least 300° C., and mixtures thereof.

T2 is an ethylenically unsaturated substance and which is preferably substantially stable at a temperature of greater than or equal to 150° C. more preferably T² is substantially stable at a temperature of greater than or equal to 300° C.;

The adduct T¹-T² is formed by contacting T¹ and T² at a temperature equal to or greater than 80° C., preferably at a temperature from 80 to 150° C.

The pyrethroid substance T¹ has preferably formula (II)

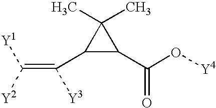

### (II)

Wherein Y¹ Y² Y³ are hydrogen atoms or a hydrocarbon radical containing from 1 to 40 carbon atoms, optionally containing heteroatoms belonging to the groups 13-17 of the periodic table, or an halogen atom; and Y⁴ is a hydrocarbon radical containing from 1 to 40 carbon atoms, optionally containing heteroatoms belonging to the groups 13-17 of the periodic table, or an halogen atom;

T¹ is preferably chosen from the group consisting of (i) compounds of the allethrin, cinerin, jasmolin and pyrethrin family, (ii) compounds of the formula III:

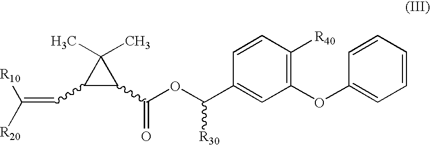

### Wherein

R¹⁰, and R²⁰, equal to or different from each other are selected from the group consisting of H, CH, OCH, SCH, CF, OCF, F, Cl or Br;
R³⁰ is selected from the group consisting of H, CH, CN, CF, F, Cl or Br;
R⁴⁰, is selected from the group consisting of H, CH, CF, OH, SH, F, Cl or Br; and
the symbol [symbol] represents a bond having the R or S configuration;
   and (iii) mixtures thereof.

More preferably the pyrethroid substance T¹ is chosen from the group consisting of deltamethrin, cypermethrin (more advantageously alpha-cypermethrin), cyhalothrin

(more advantageously h-cyhalothrin) and allethrin I

The ethylenically unsaturated substance T² is a surfactant (a) chosen preferably from amines and polyamines of the formulae IV and V, polyoxyalkylenated amines and polyamines of the formula VI and polyoxyalkylenated alkenylphenols of the formula VII:

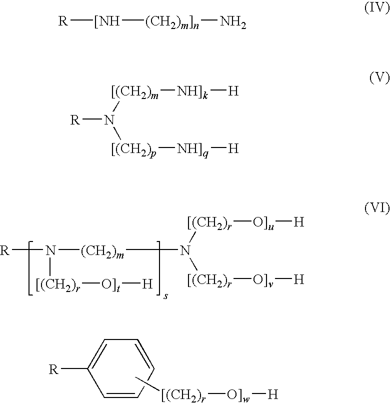

### Wherein:

R is a C₈-C₂₂, unsaturated aliphatic hydrocarbon radical having a linear (preferably) or branched chain,
k is an integer having a value of 1 to 8,
m is an integer having a value of 2 to 8,
n is an integer having a value of 0 to 8,
p is an integer having a value of 1 to 8,
q is an integer having a value of 1 to 8,
r is an integer having a value of 2 or 3,
s is an integer having a value of 0 to 8,
t is an integer having a value of 1 to 8,
u is an integer having a value of 0 to 8, and
v is an integer having a value of 0 to 8,
w is an integer having a value of 3 to 8.

The ethylenically unsaturated substance T² can also be a vinyl phosphate (b) having in its molecule the structure VIII:

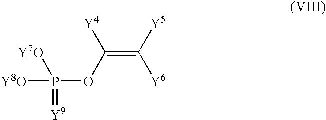

wherein
Y⁷ and Y⁸, equal to or different from each other are selected from C₁-C₄, alkyl group,
Y⁹ represents an oxygen atom or a sulphur atom, and
Y⁴, Y⁵ and Y⁶ are hydrogen atoms or a hydrocarbon radical containing from 1 to 40 carbon atoms, optionally containing heteroatoms belonging to the groups 13-17 of the periodic table, or an halogen atom; with the proviso that not more than two among Y⁴, Y⁵ and Y⁶ are hydrogen atoms, two group among Y⁴, Y⁵ and Y⁶ can also be joined to form, an heterocyclic ring containing nitrogen, oxygen or sulphur atoms.

Preferably the vinyl phosphate (b) is dichlorvos, pirimiphos-methyl, chlorpyrifos, chlorfenvinphos and/or crotoxyphos.

The material of the present invention can be easily prepared by mixing component A) and component B) heating and extruding the resulting mixture. Optionally other substance normally used in the field of polymers such as antioxidant, stabilizer and so on can be mixed before the extrusion.

Preferably component B) can be first mixed with a small portion of component A) heated and extruded so that to obtain a masterbatch. Said masterbatch containing from 15 to 30% by weight of component B) can be further mixed with component A) in order to obtain the material of the present invention.

The material of the present invention can be used in form of sheets, films, filament or fiber. Thus a further object of the present invention is a sheet, a film, a filament or a fiber obtained by the material of the present invention.

Preferably the material of the present invention is used in form of filament or fibers to obtain for example non woven fabric. The material of the present invention is further particularly suitable for the production of mosquito-nets. Thus a still further object of the present invention is a mosquito-net comprising the material of the present invention.

With the material of the present invention it is possible to have an higher concentration of the insecticidal and acaricidal substance. In particular when the MFR is comprised in the above reported range the flow of insecticidal or acaricidal substance is increased thus among other advantages when the propylene.based polymer (A) is used the activity of the insecticidal has a wider range of action with respect to the other materials that can be used.

### EXAMPLES

The proton and carbon spectra of polymers were obtained using a Bruker DPX 400 spectrometer operating in the Fourier transform mode at 120° C. at 400.13 MHz and 100.61 MHz respectively. The samples were dissolved in C₂D₂Cl₄. As reference the residual peak of C₂DHCl₄ in the ¹H spectra (5.95 ppm) and the peak of the mmmm pentad in the ¹³C spectra (21.8 ppm) were used. Proton spectra were acquired with a 45° pulse and 5 seconds of delay between pulses; 256 transients were stored for each spectrum. The carbon spectra were acquired with a 90° pulse and 12 seconds of delay between pulses and CPD (waltz 16) to remove ¹H—¹³C couplings. About 3000 transients were stored for each spectrum. Some commercial samples of propylene polymer were evaluated in the composition according to the present invention. The polymers evaluated are reported in the following table 1

TABLE 1

| | | MFR (ISO 1133) | Mmmm |
|---|---|---|---|
| Sample | Grade | g/10′ | % |
| 1 | Moplen HP552L | 6 | >92 |
| 2 | Moplen HP561R | 25 | >92 |
| 3 | Metocene HM562S | 30 | >92 |
| 4 | Moplen H552N | 12 | >92 |
| 5 | Moplen HP648T | 55 | >92 |

### Preparation of Insecticidal Component (B)

A mixture containing Deltamethrin (85 parts by weight) and dichlorvos (15 parts by weight) has been heated at 130° C. under stirring.

### Preparation of the Material

1 parts by weight of component B has been mixed with 99 parts by weight of the polymers of table 1 and the resulting compositions were pelletized in a twin screw extruder in order to obtain three samples marked respectively R1, R2, R3, R4 and R5.

### Preparation of Sheets

The resins R1, R2, R3, R4 and R5 were extruded in sheets of ca. 1.5 mm thickness, using the NMR/Kaufmann extrusion line to obtain respectively the sheets S1, S2, S3, S4 and S5

### Test of the Materials

Weighted samples of the materials S1, S2, S3, S4 and S5 (all samples having the same weight) have been stored in different boxes provided with hole for air passage. Each box has been stored in a different room. In this way contamination among the various boxes has been avoided. Every week the concentration of the insecticide within each box has been measured by closing the hole and analyzing a sample of air of each box. The concentration of the sample Si has been considered as 1 for each week and all the other have been calculated as a consequence. The results after 4 weeks are reported on table 2.

| Table | S1* | S2 | S3 | S4 | S5* |
|---|---|---|---|---|---|
| Week1 | 1.00 | 1.32 | 1.35 | 1.28 | 1.15 |
| Week2 | 1.00 | 1.34 | 1.37 | 1.28 | 1.14 |
| Week3 | 1.00 | 1.34 | 1.37 | 1.27 | 1.15 |
| Week4 | 1.00 | 1.34 | 1.33 | 1.28 | 1.15 |

*comparative

Table 1 shows that, when the propylene polymer according to the invention is used, the concentration of the insecticide in the air is higher with respect to the use of a polymer that does not meet all the features listed above. Consequently the use of the propylene polymer according to the invention results to be much more efficient.

1. A material having insecticidal and acaricidal properties comprising:
A) from 99.95 by weight to 70.0% by weight of a propylene based polymer having the following properties:
i) a Melt Flow Rate (MFR) (ISO 1133) comprised between 10 and 40; and
ii) Isotactic pentads (mmmm) higher than 90%;
B) from 0.05% to 30% by weight of an adduct of formula T¹-T² resulting from the condensation of T¹ and T², wherein
T¹ comprises at least one pyrethroid substance, which is substantially stable up to a temperature of at least 150° C.;
T² is an ethylenically unsaturated substance chosen from the group consisting of:
(a) a surfactant
(b) vinyl phospates and
(c) mixtures thereof.

2. The material according to claim 1 wherein from 99.5% to 85% by weight of A and 0.5% to 15% by weight of B is used.

3. The material according to claim 1 wherein in component A) the MFR is comprised between 12 and 35.

4. A process for producing the material of claim 1 wherein components A) and B) are mixed, heated and extruded.

5. The process according to claim 4 wherein from 15 to 30% by weight of component B) and 70% to 85% of component A) are mixed, with the mixture then being heated and extruded to form a masterbatch.

6. Sheets or films obtained from the material according to claim 1.

7. Filaments or fibers obtained from the material according to claim 1.

8. Non-woven materials obtained from the filaments or fibers according to claim 7.

9. A mosquito-net obtained by using the material of claim 1.
